(19) United States
(12) Patent Application Publication
(10) Pub. No.: US 2007/0124670 A1
(43) Pub. Date: May 31, 2007

(54) Systems, methods, and media for printing web pages

(76) Inventors: Thomas W. Finck, Rochester, MN (US); Walid Kobrosly, Round Rock, TX (US); Katherine J. Pearsall, Georgetown, TX (US); Bernadette M. Wing, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/289,122

(22) Filed: Nov. 29, 2005

(51) Int. Cl. G06F 17/00

(52) U.S. Cl. 715/526; 715/527; 715/530

(57) ABSTRACT

Systems, methods, and media for printing a Web page by modifying the Web page in response to user inputs are disclosed. Embodiments may include receiving a command to print a Web page, analyzing the Web page to be printed for one or more modifiable elements, and generating a preview of the Web page with an indication of the modifiable elements. The modifiable elements may include, for example, a margin, font size, font type, a graphic, graphic size, or a section of the Web page. Embodiments may also include receiving a Web page modification request to modify one or more modifiable elements and modifying the Web page based on the Web page modification request. Embodiments may also include transmitting a printing command including an indication of the modified Web page. Further embodiments may also include saving the modified Web page as a file.

### FIELD OF INVENTION

The present invention is in the field of data processing systems and, in particular, to systems, methods and media for printing a Web page.

### BACKGROUND

Personal computer systems are well known in the art. They have attained widespread use for providing computer power to many segments of today's modem society. Personal computers (PCs) may be defined as a desktop, floor standing, or portable microcomputer that includes a system unit having a central processing unit (CPU) and associated volatile and non-volatile memory, including random access memory (RAM) and basic input/output system read only memory (BIOS ROM), a system monitor, a keyboard, one or more flexible diskette drives, a CD-ROM or DVD-ROM drive, a fixed disk storage drive (also known as a “hard drive”), a pointing device such as a mouse, and an optional network interface adapter. One of the distinguishing characteristics of these systems is the use of a motherboard or system planar to electrically connect these components together. The use of mobile computing devices, such as notebook PCs, personal digital assistants (PDAs), sophisticated wireless phones, etc., has also become widespread. Mobile computing devices typically exchange some functionality or performance when compared to traditional PCs in exchange for smaller size, portable power, and mobility.

The widespread use of PCs and mobile computing devices in various segments of society has resulted in a reliance on computer systems both at work and at home, such as for telecommuting, news, stock market information and trading, banking, shopping, shipping, communication in the form of hypertext transfer protocol (http) and e-mail, as well as other services. Many of these functions take advantage of the communication abilities offered by the Internet or other networks, such as local area networks. Much of the information on the Internet is contained on the World Wide Web (WWW, or Web), a system of Internet servers that support documents formatted in HyperText Markup Language (HTML). A document of the WWW is called a Web page and is identified by a unique Uniform Resource Locator (URL). Users typically use browsers (software applications used to locate and display Web pages) to navigate through Websites on the Internet, intranets or other networks.

In many cases, a user desires to print out a hardcopy of a Web page for easier viewing, portability, preservation, or other reason. The user typically selects a print button on their browser to print out the Web page which they are currently viewing. Often, however, the printed page is truncated on the right side, potentially preventing the printing of important or desirable information. One solution to this problem is for the user to copy and paste the Web page into a file, load the file into another program and possibly modify it, and then print the file to ensure that all the information from the Web page is preserved. This solution suffers from a number of drawbacks, as it is time-consuming for the user to perform the multiple steps and also results in the creation of an intermediate file requiring storage space if the user forgets to delete it. There is, therefore, a need for an effective and efficient solution to print a Web page.

### SUMMARY OF THE INVENTION

The problems identified above are in large part addressed by systems, methods and media for printing a Web page. Embodiments may include receiving a command to print a Web page, analyzing the Web page to be printed for one or more modifiable elements, and generating a preview of the Web page with an indication of the modifiable elements. The modifiable elements may include, for example, a margin, font size, font type, a graphic, graphic size, or a section of the Web page. Embodiments may also include receiving a Web page modification request to modify one or more modifiable elements and modifying the Web page based on the Web page modification request. Embodiments may also include transmitting a printing command including an indication of the modified Web page. Further embodiments may include saving the modified Web page as a file.

Another embodiment provides a machine-accessible medium containing instructions effective, when executing in a data processing system, to cause the system to perform a series of operations for playing back an instant messaging session. The series of operations generally includes receiving a command to print a Web page, analyzing the Web page to be printed for one or more modifiable elements, and generating a preview of the Web page with an indication of the modifiable elements. The series of operations may also include receiving a Web page modification request to modify one or more modifiable elements and modifying the Web page based on the Web page modification request. The series of operations may also include transmitting a printing command including an indication of the modified Web page. Further embodiments may include a series of operations for saving the modified Web page as a file.

A further embodiment provides an intelligent printing system that includes a browser interface module to receive a command to print a Web page from a browser and a print preview module to generate a preview of the Web page to be printed, where the preview includes an indication of one or more modifiable elements of the Web page. The system may also include a user interface module to receive a Web page modification request that includes a request to modify one or more modifiable elements of the Web page and a Web page modifier module to modify the Web page based on the Web page modifier request. The Web page modifier module may include sub-modules such as a margin adjuster sub-module, a font adjuster sub-module, a graphics adjuster sub-module, and/or a section adjuster sub-module.

### BRIEF DESCRIPTION OF THE DRAWINGS

Advantages of the invention will become apparent upon reading the following detailed description and upon reference to the accompanying drawings in which, like references may indicate similar elements:

FIG. 1 depicts an environment for an intelligent printing system for a browser according to one embodiment;

FIG. 2 depicts a block diagram of one embodiment of a computer system suitable for use as a component of the intelligent printing system, such as a user computer system or Web server;

FIG. 3 depicts a conceptual illustration of software components of an intelligent printing applet of the intelligent printing system according to one embodiment;

FIG. 4 depicts an example of a flow chart for modifying a Web page to be printed according to one embodiment; and

FIG. 5 depicts an example of a flow chart for modifying a Web page to be printed according to a second embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The descriptions below are designed to make such embodiments obvious to a person of ordinary skill in the art.

Generally speaking, systems, methods, and media for printing a Web page by modifying the Web page in response to user inputs are disclosed. Embodiments may include receiving a command to print a Web page, analyzing the Web page to be printed for one or more modifiable elements, and generating a preview of the Web page with an indication of the modifiable elements. The modifiable elements may include, for example, a margin, font size, font type, a graphic, graphic size, or a section of the Web page. Embodiments may also include receiving a Web page modification request to modify one or more modifiable elements and modifying the Web page based on the Web page modification request. Embodiments may also include transmitting a printing command including an indication of the modified Web page. Further embodiments may include saving the modified Web page as a file.

The system and methodology of the disclosed embodiments provides for an effective and efficient mechanism to print a Web page. By allowing a user to select elements to be eliminated from the printed Web page, the user may ensure that the full breadth of a Web page is printed and that no important information is lost. The user may also reduce printing costs by quickly modifying undesirable elements of the Web page that can result in increased ink and paper usage. The modifications requested by a user may also, in some cases, improve the aesthetic appeal of the final output by eliminating unnecessary sections. The disclosed system may be implemented as an applet in some embodiments to work with a variety of browsers to provide enhanced flexibility.

While specific embodiments will be described below with reference to particular configurations of hardware and/or software, those of skill in the art will realize that embodiments of the present invention may advantageously be implemented with other substantially equivalent hardware and/or software systems. Aspects of the invention described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the invention are also encompassed within the scope of the invention.

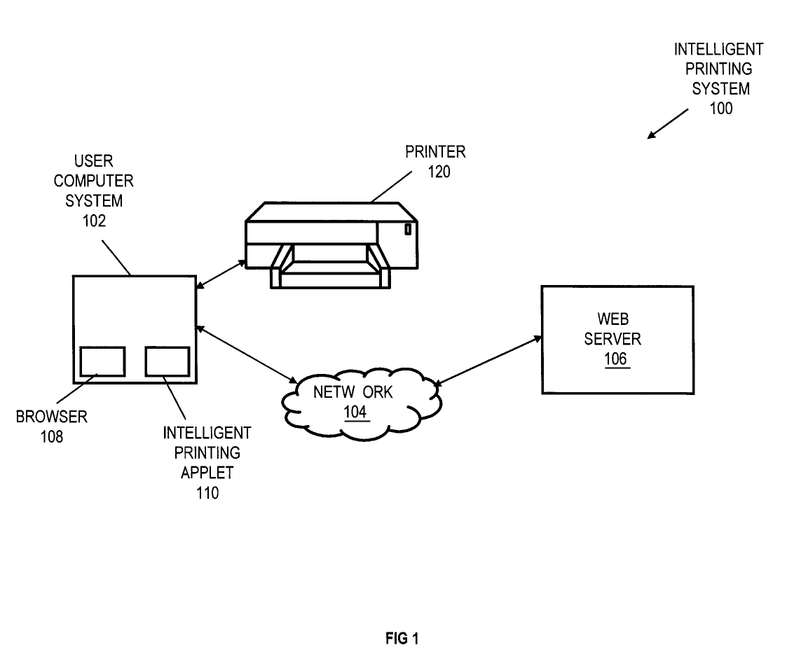

Turning now to the drawings, FIG. 1 depicts an environment for an intelligent printing system for a browser according to one embodiment. In the depicted embodiment, the intelligent printing system 100 includes a user computer system 102 in communication with a network 104. The user computer system 102 may also be in communication with a printer 120 via a wired or wireless connection such as a Universal Serial Bus (USB) or other cable, local area network (LAN), or other connection. The depicted intelligent printing system 100 also includes optional Web server 106 in communication with the user computer system 102 via network 104. User computer system 102 may include a browser 108 and an intelligent printing applet 110. Using the browser 108, a user may view Web pages on a Web server 106 via network 106. If a user desires to print a copy of a Web page, the browser 108, in conjunction with the intelligent printing applet 110, may provide the user with a preview of the Web page along with an indication of modifiable elements of the Web page that may be altered or eliminated to improve printing performance and to prevent part of the Web page from exceeding the printer's margins and not be printed. The user may then select elements to modify (either altering or eliminating those elements) to improve printing performance, such as reducing or eliminating elements to prevent exceeding the margins, wasting printer ink, or other problems. Elements of the Web page may include margins, fonts and text, graphics, sections such as advertisements or navigation bars, or other aspects of a Web page.

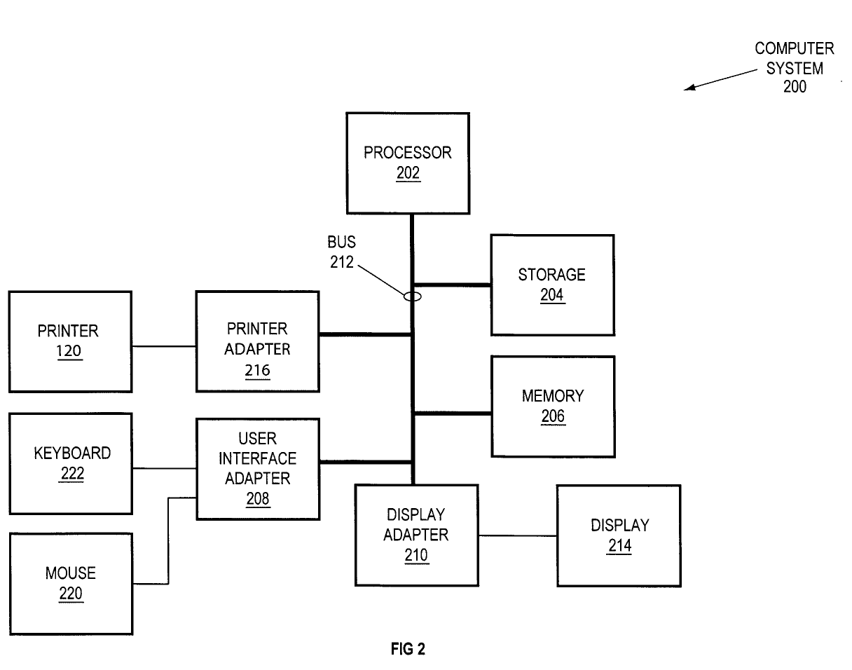

The user computer system 102 may be any computer system adapted to execute software such as a browser 108 and an intelligent printing applet 110 and to communicate with a printer 120. User computer system 102 may include one or more personal computers, workstations, servers, mainframe computers, notebook or laptop computers, desktop computers, PDAs, set-top boxes, mobile phones, wireless devices, or the like. In some embodiments, the user computer system 102 may be a computer system as described in relation to FIG. 2. Browser 108 may be a graphical browser such as Microsoft Corporation's Internet Explorer™, Netscape Communication Corporation's Navigator™, Mozilla Foundation's Mozilla, Apple Corporation's Safari™, Opera Software ASA's Opera™, etc. Browsers 108, at their most basic level of operation, permit users to connect to a given network site, download informational content from that site, and display that information to the user. To view additional information, the user of the browser 108 designates a new network address (such as by selecting a link) whose contents then replace the previously displayed information on the user's computer display.

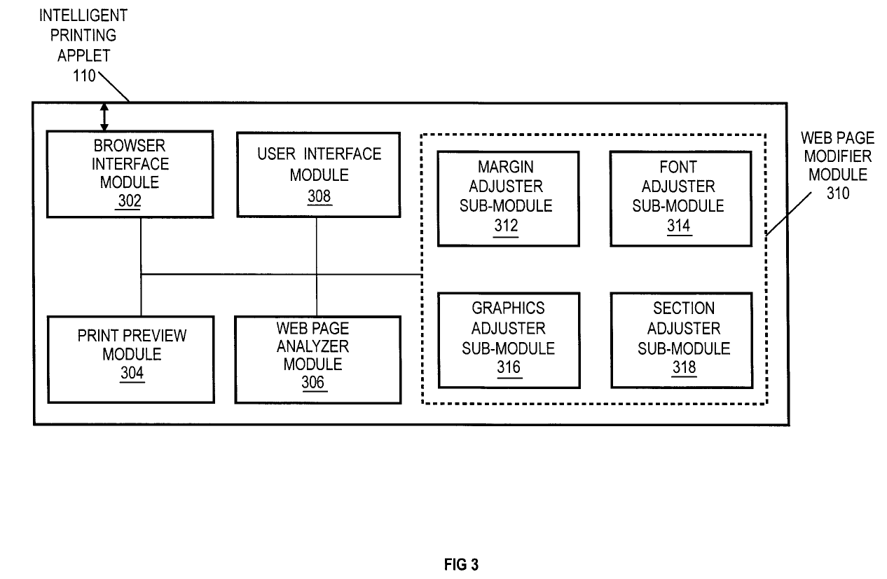

The intelligent printing applet 110 (as described in more detail in relation to FIG. 3) may, in collaboration with browser 108, analyze a Web page to determine its modifiable elements. The intelligent printing applet 110 may present a print preview to the user and receive, from the user, an indication of which elements the user wishes to modify or delete. The intelligent printing applet 110 may then modify the Web page in response to the user's request and send a print command. By allowing a user to selectively modify a Web page before printing, the user can remove elements that result in wasted ink or truncation of content. The intelligent printing applet 110 may be an applet (a software component that runs in the context of another program, which in the disclosed embodiments is browser 108). An applet typically cannot run independently from its host program but may be compatible with different versions of the host program (e.g., compatible with different kinds of browsers 108). The intelligent printing applet 110 may have the capability of interacting with and influencing the host browser 108, such as by modifying the browser's 108 response to a user's request to print a Web page. In an alternative embodiment, intelligent printing applet 110 is fully integrated into browser 108 and is not an applet, resulting in the disclosed methodology being fully incorporated into the functionality of browser 108. In this embodiment, a browser 108 may accordingly be delivered to its users with the disclosed methodology as a standard feature.

Network 104 may be any type of data communications channel, or any combination of data communication channels, such as the Internet, an intranet, a LAN, a WAN, an Ethernet network, a wireless network, a proprietary network, or a broadband cable network. Those skilled in the art will recognize, however, that the invention described herein may be implemented utilizing any type or combination of data communications channel(s).

The optional Web server 106 may be executing on one or more personal computers, workstations, servers, mainframe computers, notebook or laptop computers, desktop computers, or the like. In some embodiment, the Web server 106 may be a computer system as described in relation to FIG. 2. An example opinion tracking server 106 is an International Business Machine Corporation (IBM) eServer® server or iSeries® server. In some embodiments, the Web server 106 may accept HTTP requests from a browser 108 and deliver a Web page in HTML format. In an alternative embodiment, Web server 106 is not needed, such as when browser 108 is accessing a Web page saved on user computer system 102 or on a local network.

The systems and methodologies of the disclosed embodiments provide an efficient and effective mechanism to print a Web page. By using the disclosed intelligent print applet 110, a user may remove elements of a Web page that may prevent optimal printing. As will be described in more detail subsequently, a user may, for example, reduce or eliminate margins to ensure that the Web page prints without cutting off important content. Similarly, the user may reduce the font size or change the font type to reduce the number of printed pages or to prevent cut-off. The user may also eliminate graphics or sections of the Web pages, such as advertisements, to save color ink resources or to help fit the Web page on the printed page. By utilizing some or all of these and other options, a user may advantageously customize the printing of a Web page with the intelligent printing applet 110 to help minimize wastage and inefficiencies.

FIG. 2 depicts a block diagram of one embodiment of a computer system 200 suitable for use as a component of the intelligent printing system 100, such as a user computer system 102 or Web server 106. Other possibilities for the computer system 200 are possible, including a computer having capabilities other than those ascribed herein and possibly beyond those capabilities, and they may, in other embodiments, be any combination of processing devices such as workstations, servers, mainframe computers, notebook or laptop computers, desktop computers, PDAs, mobile phones, wireless devices, set-top boxes, or the like. At least certain of the components of computer system 200 may be mounted on a multi-layer planar or motherboard (which may itself be mounted on the chassis) to provide a means for electrically interconnecting the components of the computer system 200.

In the depicted embodiment, the computer system 200 includes a processor 202, storage 204, memory 206, a user interface adapter 208, a display adapter 210, and a printer adapter 216 connected to a bus 214. The bus 214 facilitates communication between the processor 202 and other components of the computer system 200, as well as communication between components. Processor 202 may include one or more system central processing units (CPUs) or processors to execute instructions, such as an IBMS PowerPC™ processor, an Intel Pentium® processor, an Advanced Micro Devices Inc. processor or any other suitable processor. The processor 202 may utilize storage 204, which may be non-volatile storage such as one or more hard drives, tape drives, diskette drives, CD-ROM drive, DVD-ROM drive, or the like. The processor 202 may also be connected to memory 206 via bus 212, such as via a memory controller hub (MCH). System memory 206 may include volatile memory such as random access memory (RAM) or double data rate (DDR) synchronous dynamic random access memory (SDRAM).

The user interface adapter 208 may connect the processor 202 with user interface devices such as a mouse 220 or keyboard 222. The user interface adapter 208 may also connect with other types of user input devices, such as touch pads, touch sensitive screens, electronic pens, microphones, etc. The bus 212 may also connect the processor 202 to a display, such as an LCD display or CRT monitor, via the display adapter 210. The printer adapter 216 may connect the processor with a printer 120. The printer adapter 216 may include, for example, a USB print adapter, a parallel or serial printer adapter, or a wireless printer adapter.

FIG. 3 depicts a conceptual illustration of software components of an intelligent printing applet 110 of the intelligent printing system 100 according to one embodiment. The intelligent printing applet 106 of the depicted embodiment includes a browser interface module 302, a print preview module 304, a Web page analyzer module 306, a user interface module 308, and a Web page modifier module 310. The browser interface module 302 may facilitate communications to and from, or interactions with, the browser 108. The browser interface module 302 may collaborate with browser 108 to ‘capture’ a user's Web page print request and provide that information to other components of the intelligent printing applet 110 so that modifications to the Web page can be made before printing.

The print preview module 304 may generate a print preview of the Web page to be printed based on the Web page, information regarding printer 120 and its capabilities, and the modifiable elements identified by the Web page analyzer module 306. If a user selects different elements to alter or eliminate, the print preview module 304 may regenerate the print preview of the Web page based on the modified elements. The Web page analyzer module 306 may analyze the Web page to be printed to determine one or more modifiable elements of the Web page. For example, the Web page analyzer module 306 may identify the margins (i.e., left, right, top, and bottom margins), the font size and type, any graphics, and any sections (e.g., advertisements, navigation bar, etc.) that may be modified at the user's request to improve the print. The user interface module 308 may receive user input from user input devices such as a mouse 220 or keyboard 222 and may transmit an indication of the received input to other components of the intelligent printing applet 110, as well as providing print previews or other information to a user via a display 214. The user interface module 308 may accomplish these tasks by interfacing with browser 108, such as via browser interface module 302. Alternatively, the user may also specify preferences for default settings to provide user input. For example, the user may specify that, as a default, Web page graphics will not be printed so that the intelligent printing applet 110 automatically removes graphics from any printed Web pages.

The Web page modifier module 310 may modify the Web page to be printed in response to a request to modify one or more of the Web page elements. Modification of an element may include eliminating the element or adjusting the element, such as by reducing the size of the element. The Web page modifier module 310 may include sub-modules such as a margin adjuster sub-module 312, a font adjuster sub-module 314, a graphics adjuster sub-module 316, and a section adjuster sub-module 318 to perform its tasks. The margin adjuster sub-module 312 may, in response to a request, modify the Web page by reducing or eliminating one or more margins. The margin adjuster sub-module 312 may, for example, reduce the size of the left margin of a Web page so that the right edge of printable content is not cut-off and to ensure that the entire width of the page is printed. In some embodiments, the margin adjuster sub-module 312 will ensure that the left margin is not reduced too much so as to conflict with the minimum margins of printer 120. Similarly, the font adjuster sub-module 314 may, in response to a request, modify the Web page to ensure its entire width is printed by reducing the size of the font used for all or part of the Web page text or by changing the font type to a smaller type.

The graphics adjuster sub-module 316 and section adjuster sub-module 318 may modify the Web page by eliminating elements (or, alternatively, by reducing their size). The graphics adjust sub-module 316 may, in response to a request, eliminate or adjust any graphics on the Web page. Graphics may include images or pictures, for example, in formats such as jpeg, tiff, pdf, or other formats. By eliminating or reducing graphics, the Web page may be more easily printed and other content of the Web page may accordingly be preserved. Moreover, a user desiring to save on printer usage costs may elect to eliminate graphics so as to preserve color inks, which may be relatively expensive when compared to black ink. The section adjuster sub-module 318 may similarly eliminate or reduce sections of the Web page selected by the user. Sections may include advertisements (e.g., banner advertisements, embedded advertisements, advertisements along the left or right edge of the Web page, etc.), navigation bars (vertical or horizontal), or any other definable portion of a Web site. In many cases, the user may not need to or desire to print particular sections of a Web page, making the ability to selectively eliminate them from the final print desirable. A user, for example, may wish to eliminate advertisements from a printed Web page to ensure the printed page fits within the print area, to reduce ink usage, and to produce a more aesthetically pleasing output. In another example, a user may wish to eliminate the navigation bar from a printed Web page to improve the printed output, which may be particularly useful when the navigation bar is vertically-oriented and thus can result in cropping of the right side of the page.

While the sub-modules of the Web page modifier module 310 are described separately, they may be used in any combination to modify a Web page to be printed. A user, for example, may wish to modify the Web page by reducing the left margin and decreasing the font size as the combined effect will allow the entire breadth of the Web page to be printed. In this example, the Web page modifier module 310 may invoke both the margin adjuster sub-module 312 and the font adjuster sub-module 314 to perform its task.

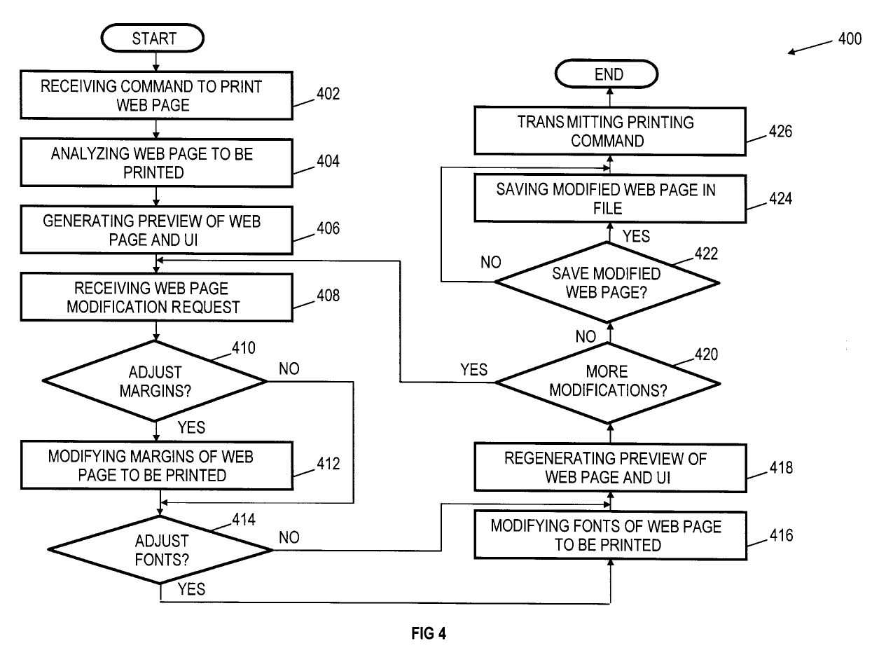

FIG. 4 depicts an example of a flow chart 400 for modifying a Web page to be printed according to one embodiment. The method of flow chart 400 may be performed, in one embodiment, by components of the intelligent printing applet 110. Flow chart 400 begins with element 402, where the browser interface module 302 may receive a command to print a Web page. The command to print the Web page may originate with the user selecting a print button or otherwise requesting a print in browser 108. The Web page analyzer module 306 may then analyze the Web page for modifiable elements at element 404. The Web page analyzer module 306 may identify some or all of the modifiable elements on the Web page. The print preview module 304 may then generate and display a preview of the Web page at element 406. The print preview may include an indication of modifiable elements on the display. For example, a margin may be highlighted if one or more margins are modifiable elements of the particular Web page. The print preview module 304 may also display a user interface to facilitate selection of modifiable elements or other actions by a user. The user interface may provide for a means for a user to select which elements they would like to modify and, if relevant, the extent of that modification. A user could select, for example, to reduce the left margin by 50 percent and to eliminate graphics. The print preview module 304 may then regenerate the preview in response to the user's selections so that they can view the predicted results of their selections and modify their selections, as necessary.

The intelligent printing applet 110 may receive a Web page modification request from a user at element 408. The Web page modification request may include an indication of one or more modifications, such as to modify the margins or fonts, the user desires to make to the Web page for printing. The Web page modifier module 310 may determine at decision block 410 whether the Web page modification request includes a request to adjust one or more margins. If the Web page modification request does include a request to adjust one or more margins, the method of flow chart 400 may continue to element 412, where the margin adjuster sub-module 312 may adjust the appropriate margins of the Web page. The Web page modifier module 310 may also determine at decision block 414 whether the Web page modification request includes a request to adjust any of the fonts of the Web page, including the font size or font type. If the Web page modification request does include a request to adjust a font, the method of flow chart 400 may continue to element 416, where the font adjuster sub-module 314 may adjust the fonts as requested. As described previously, the user may request to modify either the size or type of font. In some embodiments, the user may request the font be modified for only a selected portion of text, such as if the user only wanted to modify the font for titles or headers in a case where they were too large.

After making the modifications requested by the user, the print preview module 304 may regenerate and redisplay the modified Web page to the user at element 408. The user may then, using the user interface, select either to make more modifications or to print the Web page as modified. If, at decision block 420, the intelligent printing applet 110 determines that the user desires to make more modifications, the method of flow chart 400 returns to element 408 to receive and process additional modifications. If, at decision block 420, the intelligent printing applet 110 determines that the user is satisfied with the modified Web page, the method of flow chart 400 continues to decision block 422. In this fashion, the intelligent printing applet 110 may allow the user to iteratively modify and view the results of their modifications until the desired print preview is achieved.

Once the user is finished modifying the previewed Web page, the intelligent printing applet 110 may optionally determine at decision block 422 whether the user desires to save the modified Web page. If the user desires a saved version, the method of flow chart 400 continues to element 424, where the intelligent printing applet 110 may save the modified Web page in a file on the user computer system 102. Otherwise, the method of flow chart 400 may continue to element 426, where the intelligent printing applet 110 transmits a printing command, after which the method terminates. The intelligent printing applet 110 may transmit the printing command to the browser 108 or to the printer 120, as appropriate.

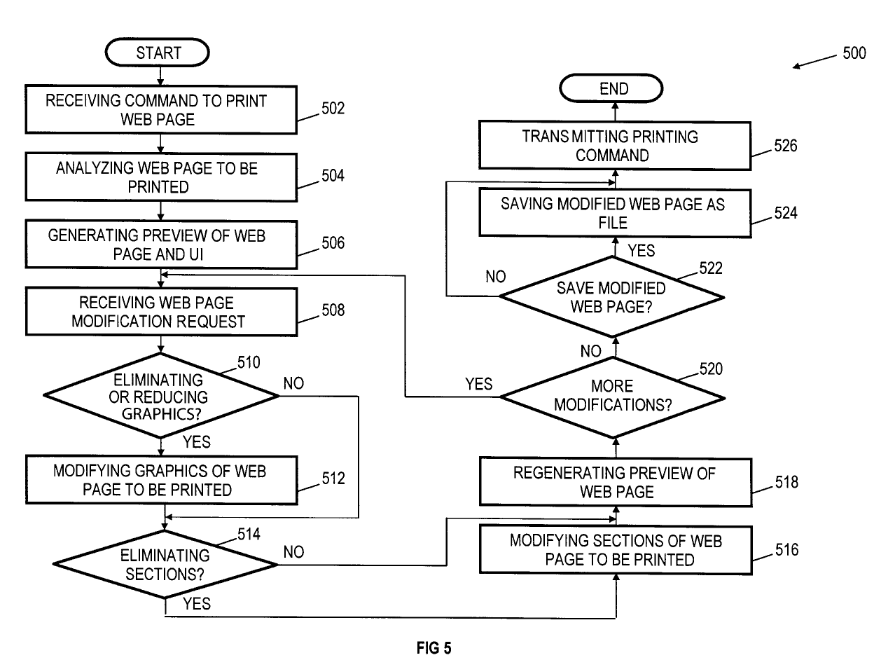

FIG. 5 depicts an example of a flow chart 500 for modifying a Web page to be printed according to a second embodiment. The method of flow chart 500 may be performed, in one embodiment, by components of the intelligent printing applet 110. The method of flow chart 500 may be substantially similar to that of flow chart 400 except that the two methods modify different elements of a Web page. Accordingly, duplicate text between the two methods need not be repeated for the sake of brevity. Flow chart 500 begins with element 502, where the browser interface module 502 may receive a command to print a Web page. The Web page analyzer module 306 may then analyze the Web page for modifiable elements at element 504. The print preview module 304 may then generate and display a preview of the Web page at element 506. The print preview module 304 may also display a user interface to facilitate selection of modifiable elements or other actions by a user.

The intelligent printing applet 110 may receive a Web page modification request from a user at element 508. The Web page modification request may include an indication of one or more modifications, such as to reduce or eliminate graphics or sections, the user desires to make to the Web page for printing. The Web page modifier module 310 may determine at decision block 510 whether the Web page modification request includes a request to eliminate or reduce the graphics on the Web page. If the Web page modification request does include a request to adjust the graphics, the method of flow chart 500 may continue to element 512, where the graphics adjuster sub-module 316 may eliminate or reduce the appropriate graphics from the Web page. The Web page modifier module 310 may also determine at decision block 514 whether the Web page modification request includes a request to modify any sections of the Web page, such as a request to eliminate or reduce the size of one or more sections. The user may request, for example, to eliminate the navigation bar from the Web page before printing. If the Web page modification request does include a request to modify one or more sections, the method of flow chart 500 may continue to element 516, where the section adjuster sub-module 318 may reduce or eliminate sections as requested.

After making the modifications requested by the user, the print preview module 304 may regenerate and redisplay the modified Web page to the user at element 508. The user may then, using the user interface, select either to make more modifications or to print the Web page as modified. If, at decision block 520, the intelligent printing applet 110 determines that the user desires to make more modifications, the method of flow chart 500 returns to element 508 to receive and process additional modifications. If, at decision block 520, the intelligent printing applet 110 determines that the user is satisfied with the modified Web page, the method of flow chart 500 continues to decision block 522. In this fashion, the intelligent printing applet 110 may allow the user to iteratively modify and view the results of their modifications until the desired print preview is achieved.

Once the user is finished modifying the previewed Web page, the intelligent printing applet 110 may optionally determine at decision block 522 whether the user desires to save the modified Web page. If the user desires a saved version, the method of flow chart 500 continues to element 524, where the intelligent printing applet 110 may save the modified Web page in a file on the user computer system 102. Otherwise, the method of flow chart 500 may continue to element 526, where the intelligent printing applet 110 transmits a printing command, after which the method terminates. The intelligent printing applet 110 may transmit the printing command to the browser 108 or to the printer 120, as appropriate.

While the two flow charts are depicted as separate methods, one skilled in the art will recognize that they may be combined in any fashion. For example, an embodiment of the intelligent printing applet 110 may be able to modify margins, fonts, graphics, and sections and thus combine elements from both flow chart 400 and flow chart 500 into one process.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for printing a Web page. It is understood that the form of the invention shown and described in the detailed description and the drawings are to be taken merely as examples. It is intended that the following claims be interpreted broadly to embrace all the variations of the example embodiments disclosed.

What is claimed is:

1. A method for printing a Web page, the method comprising:
receiving a command to print a Web page;
analyzing the Web page to be printed for one or more modifiable elements and generating a preview of the Web page, the Web page preview comprising an indication of modifiable elements; receiving a Web page modification request, the Web page modification request comprising a request to modify one or more modifiable elements;
modifying the Web page based on the Web page modification request; and
transmitting a printing command, the printing command comprising an indication of the modified Web page.

2. The method of claim 1, further comprising saving the modified Web page as a file.

3. The method of claim 1, wherein the one or more modifiable elements comprise one or more of a margin, font size, font type, a graphic, graphics size, a section, an advertisement, or a navigation bar.

4. The method of claim 1, wherein the Web page modification request comprises a request to adjust one or more of a left margin, a right margin, a top margin, a bottom margin, font type, font size, or graphics size.

5. The method of claim 1, wherein the Web page modification request comprises a request to eliminate graphics from the Web page.

6. The method of claim 1, wherein the Web page modification request comprises a request to eliminate one or more sections from the Web page.

7. The method of claim 6, wherein at least one of the one or more eliminated sections is an advertisement.

8. The method of claim 1, modifying the Web page based on the Web page modification request comprises one or more of modifying a margin, modifying a font, modifying graphics, eliminating graphics, eliminating a section, or eliminating an advertisement.

10. A machine-accessible medium containing instructions effective, when executing in a data processing system, to cause said data processing system to perform operations comprising:
receiving a command to print a Web page;
analyzing the Web page to be printed for one or more modifiable elements and generating a preview of the Web page, the Web page preview comprising an indication of modifiable elements;
receiving a Web page modification request, the Web page modification request comprising a request to modify one or more modifiable elements;
modifying the Web page based on the Web page modification request; and
transmitting a printing command, the printing command comprising an indication of the modified Web page.

11. The machine-accessible medium of claim 10, further comprising saving the modified Web page as a file.

12. The machine-accessible medium of claim 10, wherein the one or more modifiable elements comprise one or more of a margin, font size, font type, a graphic, graphics size, a section, an advertisement, or a navigation bar.

13. The machine-accessible medium of claim 10, wherein the Web page modification request comprises a request to adjust one or more of a left margin, a right margin, a top margin, a bottom margin, font type, font size, or graphics size.

14. The machine-accessible medium of claim 10, modifying the Web page based on the Web page modification request comprises one or more of modifying a margin, modifying a font, modifying graphics, eliminating graphics, eliminating a section, or eliminating an advertisement.

15. An intelligent printing system, the system comprising:
a browser interface module, the browser interface module being adapted to receiving a command to print a Web page from a browser;
a print preview module, the print preview module being adapted to generate a preview of the Web page to be printed, the Web page preview comprising an indication of one or more modifiable elements of the Web page;
a user interface module, the user interface module being adapted to receive a Web page modification request, the Web page modification request comprising a request to modify one or more modifiable elements of the Web page; and
a Web page modifier module in communication with the user interface module, the Web page modifier module being adapted to modify the Web page based on the Web page modification request.

16. The server of claim 15, further comprising a Web page analyzer module, the page analyzer module being adapted to analyze the Web page to be printed to determine the one or more modifiable elements of the Web page.

17. The server of claim 15, wherein the Web page modifier module comprises a margin adjuster sub-module, the margin adjuster sub-module being adapted to adjust one or more margins of the Web page.

18. The server of claim 15, wherein the Web page modifier module comprises a font adjuster sub-module, the font adjuster sub-module being adapted to adjust one or more of a font size or a font type.

19. The server of claim 15, wherein the Web page modifier module comprises a graphics adjuster sub-module, the graphics adjuster sub-module being adapted to eliminate one or more graphics of the Web page.

20. The server of claim 15, wherein the Web page modifier module comprises a section adjuster sub-module, the section adjuster sub-module being adapted to eliminate one or more sections of the Web page.
